(19) United States
(12) Patent Application Publication
(10) Pub. No.: US 2002/0184019 A1
(43) Pub. Date: Dec. 5, 2002

(54) Method of using empirical substitution data in speech recognition

(75) Inventors: Matthew W. Hartley, Boynton Beach, FL (US); James R. Lewis, Delray Beach, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/871,403

(22) Filed: May 31, 2001

(51) Int. Cl. G10L 15/08; G10L 15/12

(52) U.S. Cl. 704/240

(57) ABSTRACT

A method of speech recognition can include receiving at least one spoken word and performing speech recognition to determine a recognition result. The spoken word can be compared to the recognition result to determine if the recognition result is an incorrectly recognized word. The spoken word can be identified as an alternate word candidate for the incorrectly recognized word.

### BACKGROUND OF THE INVENTION

1. Technical Field

This invention relates to the field of speech recognition, and more particularly, to the use of empirically determined data for use with error recovery.

2. Description of the Related Art

Speech recognition is the process by which an acoustic signal received by microphone is converted to a set of text words, numbers, or symbols by a computer. These recognized words then can be used in a variety of computer software applications for purposes such as document preparation, data entry, and command and control. Improvements to speech recognition systems provide an important way to enhance user productivity.

Speech recognition systems can model and classify acoustic signals to form acoustic models, which are representations of basic linguistic units referred to as phonemes. Upon receiving and digitizing an acoustic speech signal, the speech recognition system can analyze the digitized speech signal, identify a series of acoustic models within the speech signal, and determine a recognition result corresponding to the identified series of acoustic models. Notably, the speech recognition system can determine a measurement reflecting the degree to which the recognition result phonetically matches the digitized speech signal.

Speech recognition systems also can analyze the potential word candidates with reference to a contextual model. This analysis can determine a probability that the recognition result accurately reflects received speech based upon previously recognized words. The speech recognition system can factor subsequently received words into the probability determination as well. The contextual model, often referred to as a language model, can be developed through an analysis of many hours of human speech. Typically, the development of a language model can be domain specific. For example, a language model can be built reflecting language usage within a legal context, a medical context, or for a general user.

The accuracy of speech recognition systems is dependent on a number of factors. One such factor can be the context of a user spoken utterance. In some situations, for example where the user is asked to spell a word, phrase, number, or an alphanumeric string, little contextual information can be available to aid in the recognition process. In these situations, the recognition of individual letters or numbers, as opposed to words, can be particularly difficult because of the reduced contextual references available to the speech recognition system. This can be particularly acute in a spelling context, such as where a user provides the spelling of a name. In other situations, such as a user specifying a password, the characters can be part of a completely random alphanumeric string. In that case, a contextual analysis of previously recognized characters offers little, if any, insight as to subsequent user speech.

Still, situations can arise in which the speech recognition system has little contextual information from which to recognize actual words. For example, when a term of art is spoken by a user, the speech recognition system can lack a suitable contextual model to process such terms. In consequence, once the term of art is encountered, similar to the aforementioned alphanumeric string situation, that term of art provides little insight for predicting subsequent user speech.

Another factor which can affect the recognition accuracy of speech recognition systems can be the quality of an audio signal. Oftentimes, telephony systems use low quality audio signals to represent speech. The use of low quality audio signals within telephony systems can exacerbate the aforementioned problems because a user is likely to provide a password, name, or other alphanumeric string on a character by character basis when interacting with an automated computer-based system over the telephone.

In light of the aforementioned limitations with regard to accurate speech recognition, varying methods of error recovery have been implemented. One such method, which can be responsive to a user initiating a correction session, can be presenting alternate selections from which a replacement for an incorrectly recognized word can be selected. Within conventional speech recognition systems, the alternate selections typically are determined by the speech recognition system itself. For example, the alternates can be words or phrases which have a spelling similar to the incorrectly recognized word. Still, the alternates can be so called “N-best” lists comprising word candidates which the speech recognition system had initially determined to be a possible recognition result for a received user spoken utterance, but ultimately did not select as the correct recognition result.

Although “N-best” lists can be useful with regard to error recovery, not all speech recognition systems are configured to make use of such lists. Moreover, in light of the aforementioned limitations relating to speech recognition accuracy, and because alternatives within an “N-best” list can be determined by the speech recognition system, the alternates can be inaccurate interpretations of received user speech.

### SUMMARY OF THE INVENTION

The invention disclosed herein provides a method for empirically determining alternate word candidates for use with a speech recognition system. The word candidates, which can be one or more individual characters, words, or phrases, can be empirically determined substitution alternates that can be used during error recovery. For example, in cases wherein the speech recognition system determines that a likelihood exists that a recognition result is inaccurate, or in response to a user request, the empirically determined word candidates can be presented as potential correct replacements for the incorrect recognition result. Notably, the alternate word candidates can be used in place of so called “N-best” lists wherein a speech recognition system typically relies upon internally determined alternate word candidates. Accordingly, the invention disclosed herein can be incorporated within an existing speech recognition system or speech recognition engine.

One skilled in the art will recognize that empirically determined substitution lists can provide fewer, more focused alternate candidates than “N-best” lists, even in cases where a speech recognition system is capable of determining an “N-best” list. This can be especially true in cases wherein strong empirical evidence indicates that if the speech recognition system produces a particular recognition result, that recognition result was actually spoken by the speaker.

One aspect of the present invention can include a method of speech recognition which can include receiving at least one spoken word and performing speech recognition to determine a recognition result. The spoken word can be a word, a character, or a letter. The word can be recorded and provided to the speech recognition system or directly spoken into the speech recognition system. The spoken word can be compared to the recognition result to determine if the recognition result is an incorrectly recognized word. The spoken word can be identified as an alternate word or letter candidate, as the case may be, for the incorrectly recognized word. The alternate word candidate can be presented as a replacement for a subsequent incorrect recognition result. For example, the alternate word candidate can be presented through a graphical user interface or an audio user interface including an audio only user interface such as a voice browser or a telephonic interface.

The method further can include calculating a conditional probability for the alternate word candidate. The alternate word candidate can have a conditional probability greater than a predetermined minimum threshold. Regardless, the incorrect recognition result and the alternate word candidate can be stored and associated in a data store. The conditional probability corresponding to the alternate word candidate also can be stored and associated with the alternate word candidate and the incorrect recognition result. Alternatively, the data store can include an indication of the conditional probability corresponding to the alternate word candidate.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a pictorial illustration of one aspect of the invention disclosed herein.

FIG. 2 is a flow chart illustrating an exemplary method of the invention.

FIGS. 3A and 3B, taken together, are a chart illustrating empirically determined data corresponding to specified user spoken utterances and recognition results in accordance with the inventive arrangements.

FIG. 4 is another chart illustrating empirically determined alternate word candidates in accordance with the inventive arrangements.

### DETAILED DESCRIPTION OF THE INVENTION

The invention disclosed herein provides a method for empirically determining alternate word candidates for use with a speech recognition system. The word candidates, which can be one or more individual characters, words, or phrases, can be empirically determined substitution alternates that can be used during error recovery. For example, in cases wherein the speech recognition system determines that a likelihood exists that a recognition result is inaccurate, the empirically determined word candidates can be potential correct replacements for the incorrect recognition result.

The word candidates can be determined from an analysis of actual dictated text as compared to the recognized dictated text from the speech recognition system. A measure referred to as a conditional probability can reflect the likelihood that when the speech recognition system produces a particular recognition result, that result was derived from a particular user spoken utterance or is an accurate reflection of a received user spoken utterance. The conditional probability reflects the likelihood that a particular user spoken utterance was received by the speech recognition system based upon a known condition, in this case the recognition result. Thus, contrary to a confidence score which can be used during the speech recognition process to effectively “look ahead” to recognize a user spoken utterance based upon previously recognized text, the conditional probability is a measure which “looks back” from the standpoint of a completed recognition result.

In other words, the conditional probability can be a measure of the accuracy of the speech recognition process for a particular recognized character, word, or phrase. For example, an empirical analysis can reveal that when the speech recognition system outputs a recognition result of “A”, there is an 86% probability that the speech recognition system has correctly recognized the user spoken utterance specifying “A”. Similarly, the same analysis can reveal that when the speech recognition system outputs a recognition result of “A”, there is a 14% probability that the speech recognition system incorrectly recognized a user spoken utterance specifying “K”. The empirical analysis also can determine a list of probable alternate word candidates. Taking the previous example, the letter “K” can be an alternate word candidate for “A”. The candidates can be ordered according to the conditional probability associated with each word candidate.

One skilled in the art will recognize that although the alternate word candidates can be can be phonetically similar or substantially phonetically equivalent to the recognition result, such is not always the case. Rather, the candidates can be any character, word, or phrase which has been identified through an empirical analysis of recognition results and dictated text as being an alternate word candidate corresponding to a particular recognizable character, word, or phrase.

Though the invention can be used with words, the invention can be particularly useful with regard to determining alternate word candidates when receiving individual characters such as letters, numbers, and symbols, including international symbols and other character sets. The present invention can be used to provide alternate word candidates for error recovery in the context of a user specifying a character string on a character by character basis. For example, the invention can be used when a user provides a password over a telephone connection. In that case, any previously recognized characters of the password provide little or no information regarding a next character to be received and recognized. The language model provides little help to the speech recognition system. Accordingly, empirically determined word candidates can be used as potential correct replacements for the incorrect recognition result.

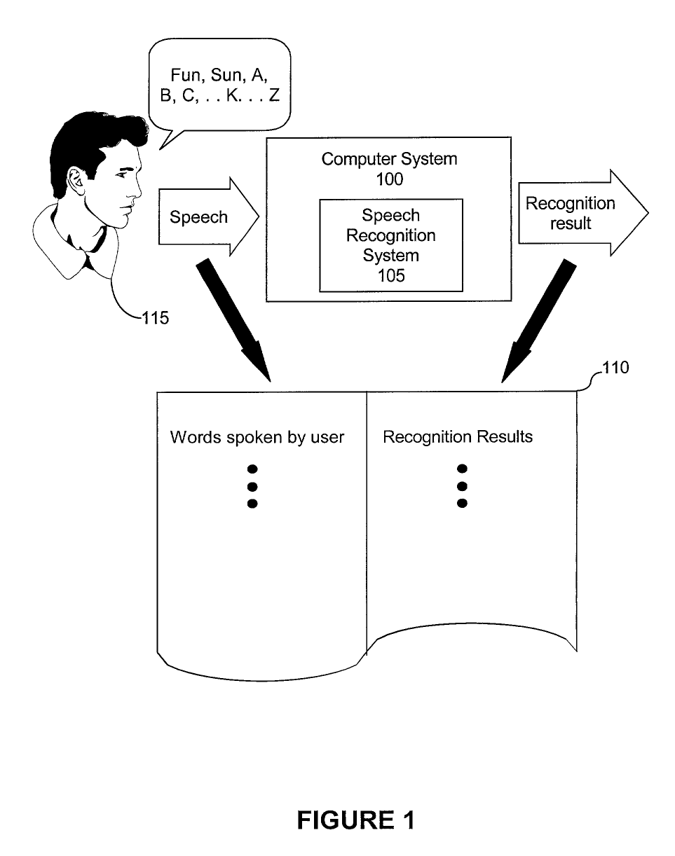

FIG. 1 is a pictorial illustration depicting a user 115 interacting with a computer system 100 having a speech recognition system 105 executing therein. A document 110 can be provided for recording words specified by a user spoken utterance and corresponding recognition results. The computer system 100 can be any of a variety of commercially available high speed multimedia computers equipped with a microphone for receiving user speech or suitable audio interface circuitry for receiving recorded user spoken utterances in either analog or digital format. The speech recognition system 105 can be any of a variety of speech recognition systems capable of converting speech to text. Such speech recognition systems are commercially available from manufacturers such as International Business Machines Corporation and are known in the art.

The document 110 serves to provide a record of speech input and corresponding recognized text output. As such, though document 110 is depicted as a single document, it can be implemented as one or more individual documents. For example, the document 110 can be one or more digital documents such as spreadsheets, word processing documents, XML documents, or the like, an application program programmed to perform empirical analysis as described herein, or a paper record.

As shown in FIG. 1, the user 115 can speak into a microphone operatively connected to the computer system 100. Speech signals from the microphone can be digitized and made available to the speech recognition system 105 via conventional computer circuitry such as a sound card. Alternatively, recorded user spoken utterances can be provided to the speech recognition system in either analog or digital format. Regardless, the speech recognition system can determine a recognition result or textual interpretation of the received user speech.

The characters, words, or phrases specified by the user spoken utterances provided to the speech recognition system can be recorded within document 110 such that a record of the user spoken utterances can be developed. The recognition results corresponding to each user spoken utterance also can be recorded within document 110. For example, the user 115 can speak the following user specified words “fun”, “sun”, “A”, “B”, “C”, “K”, and “Z”. The user specified words can be recorded within document 110. The recognition results determined for each of the aforementioned words also can be recorded within document 110. Consequently, a statistical analysis of user specified words as compared to each corresponding recognition result can be performed.

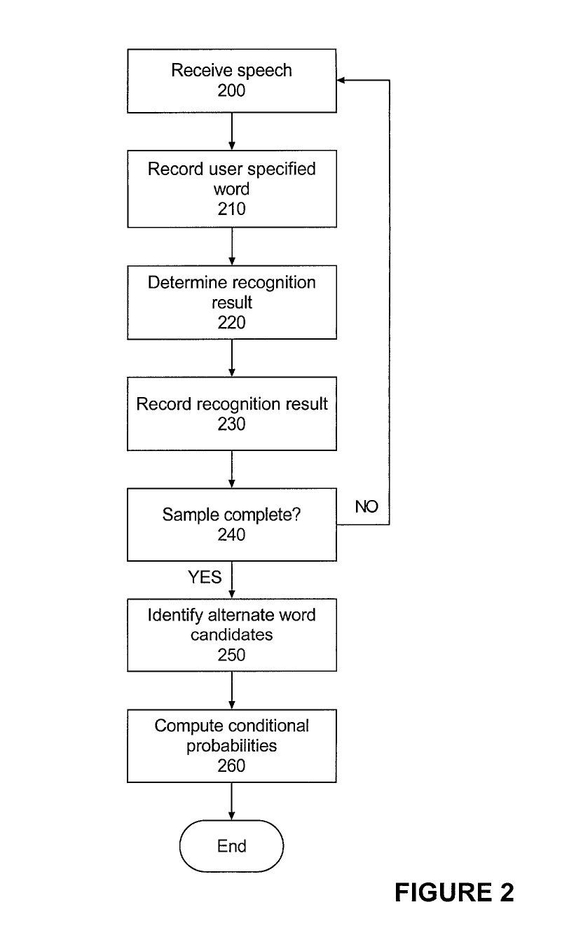

FIG. 2 is a flow chart illustrating an exemplary method for empirically determining alternate word candidates corresponding to recognizable words in accordance with the inventive arrangements disclosed herein. The word candidates, as well as the recognizable words can be words or characters such as letters, numbers, and symbols, including international symbols and other character sets. Beginning in step 200, a user spoken utterance can be received. For example, a user spoken utterance specifying the word “A” can be received. Notably, the user speech can be directly spoken into the speech recognition system or can be a recording played into the speech recognition system. In step 210, the word specified by the user spoken utterance can be recorded for later analysis. Accordingly, the specified word “A” can be recorded for later comparison to its corresponding recognition result. In step 220, a recognition result corresponding to the received user spoken utterance can be determined. For example, if the user spoken utterance specified the word “A”, the recognition result can be “A”, a correct recognition result, or possibly “K”, an incorrect recognition result. Regardless of whether the recognition result is correct or incorrect, the recognition result can be recorded in step 230 and associated with the corresponding user spoken utterance and specified word.

In step 240, a determination can be made as to whether enough data has been collected to build a suitable statistical model. The data sample can include data from more than one speaker wherein each speaker, or user, can provide a set of user spoken utterances to the speech recognition system. Also, each speaker can provide the same user spoken utterance to the speech recognition system multiple times. If there is not enough data to construct a suitable statistical model, the method can repeat steps 200 through 240 to receive and process additional speech. For example, during a subsequent iteration, a recognition result of “J” can be determined despite the user speaking the word “A” into the speech recognition system. If enough data has been obtained, the method can continue to step 250.

In step 250, alternate word candidates corresponding to user specified and recognizable words can be determined from the collected test data. The alternate word candidates can be user specified words which were incorrectly recognized by the speech recognition system as particular words. For example, if the user specified word “I”, was incorrectly recognized as the word “A”, then the user specified word “I” can be an alternate word candidate for “A”.

In step 260, a conditional probability for user specified words can be determined from a statistical analysis of the test data. As previously mentioned, a conditional probability can reflect the likelihood that when the speech recognition system produces a particular recognition result, that result is an accurate reflection of the user spoken utterance. The conditional probability can be the ratio of the total number of times a particular word, such as “A” is provided to the speech recognition system in the form of speech, to the total number of times “A” is output as a recognition result. For example, a conditional probability of 0.86 for a recognition result of “A” indicates that in 86% of the instances wherein “A” was a recognition result, the user spoken utterance specified the word “A”.

Similar calculations can be performed for incorrect recognitions which can be the alternate word candidates. For example, if the user specified word “I” was incorrectly recognized as the word “A”, then “I” can be an alternate word candidate for “A”. The conditional probability of the alternate word candidate “I” in relation to “A” can be the ratio of the total number of times the user specified word “I” was provided to the speech recognition system to the total number of times “A” was the recognition result. Accordingly, if the recognition result of “A” was returned for the user specified words of “A” and “I”, then “I” can have a conditional probability of 0.14. In other words, 14% of the instances wherein “A” was the recognition result, the user specified word “I” was the input.

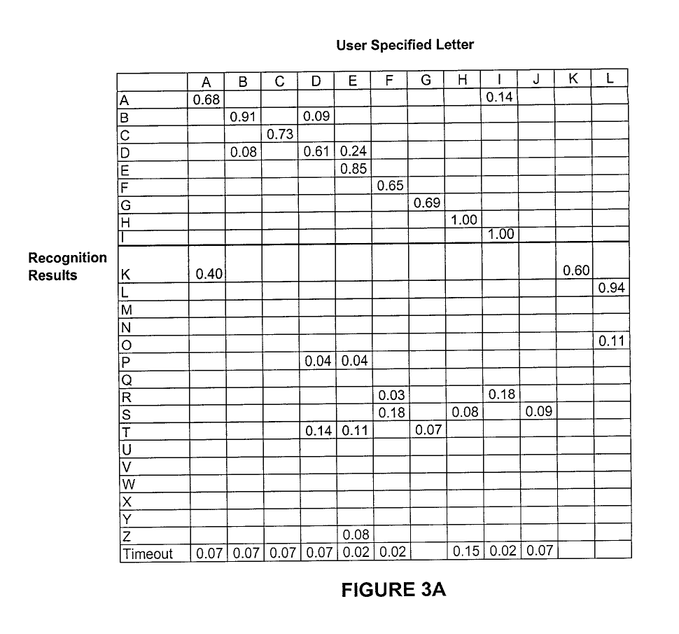

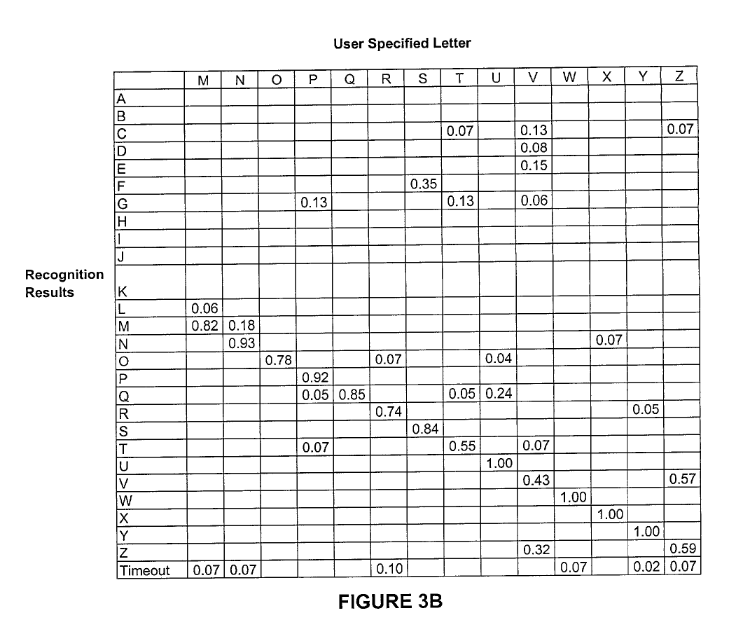

FIGS. 3A and 3B, taken together, are an exemplary table illustrating empirically determined data which can be determined using the method of FIG. 2. The exemplary table of FIGS. 3A and 3B includes user spoken utterances and corresponding recognition results in accordance with the inventive arrangements. The data contained in FIGS. 3A and 3B is directed to a study of the recognition of alphabetic characters by a specific speech recognition system. As shown in FIGS. 3A and 3B, the left-most vertical column contains letters which have been returned by the speech recognition system as recognition results and are labeled accordingly. The top row of letters is labeled “User Specified Letter” denoting the letters actually spoken by the user and received as speech by the speech recognition system. The bottom row of numbers labeled “Timeout” represents an error condition wherein no recognition result was obtained.

Referring to FIG. 3A, for example, the statistical analysis reveals that in 86% of the instances wherein the speech recognition system determines the letter “A” to be the recognition result, the received user spoken utterance specified the letter “A”. In other words, the speech recognition system was correct in 86% of the times that an “A” was the recognition result. Similarly, 40% of the instances wherein the letter “K” was the recognition result, the user specified letter actually was an “A”.

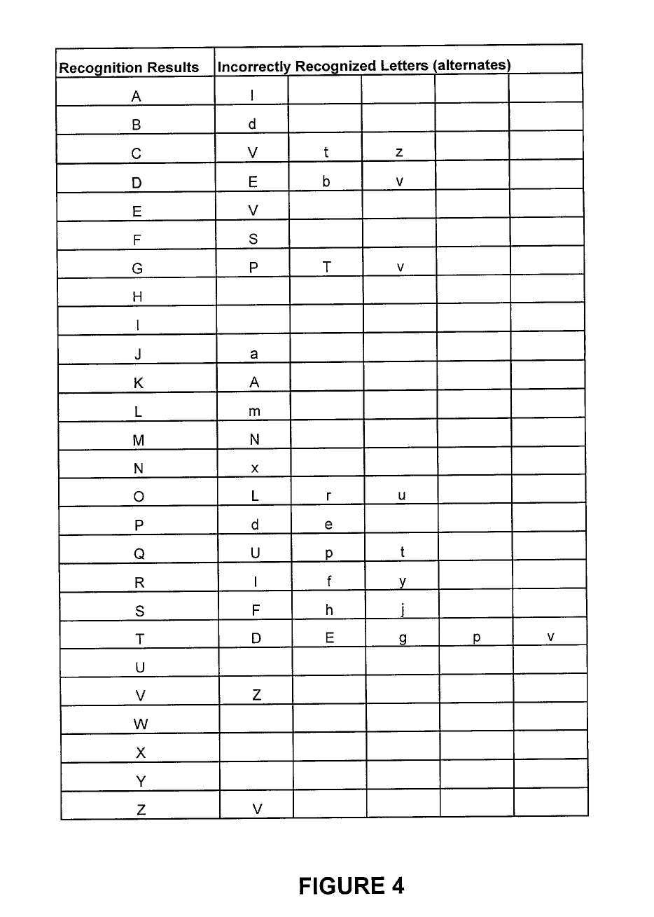

From the data illustrated in FIGS. 3A and 3B, a listing of likely word candidates can be determined. Accordingly, FIG. 4 is an exemplary table of likely alternate word candidates for recognizable words as determined from FIGS. 3A and 3B. The first column of FIG. 4 shows the word, in this case the character, that was returned by the speech recognition system as a recognition result. For each of the letters in the first column, if a user specified letter in FIGS. 3A or 3B was incorrectly recognized as one of the letters in the first column, the user specified letter appears in the row with the returned letter. Consequently, as shown in FIG. 4, the returned letter “K” in the first column has the letter “A” listed as an alternate word candidate. Notably, referring back to FIG. 3A, a recognition result of “K” had a 40% probability of being an incorrectly recognized “A”. Accordingly, “A”is an alternate word candidate for the letter “K”.

If in FIGS. 3A and 3B, a recognition result had a 10% or less probability of being returned as an incorrect recognition result for a particular user specified word, the user specified word can be listed in FIG. 4 in lower case. For example, from FIGS. 3A and 3B, the letter “O” corresponds to alternate word candidates “L”, “r”, and “u”. A recognition result of “O” has an 11% probability of being an incorrect recognition of a speech input specifying the letter “L”, a 7% chance of being an incorrect recognition of the letter “r”, and a 4% chance of being an incorrect recognition of the letter “u”. Accordingly, the letter “L” is listed in upper case, while both “r” and “u” are listed in lower case. The notation illustrated provides an intuitive method of noting a threshold level, in this case 10%, which can be used to filter alternate word candidates within a speech enabled application, a speech recognition engine, or a speech recognition system.

It should be appreciated that the threshold level need not be maintained at 10% and can be any appropriate level, for example between 0 and 1 if normalized or 0% and 100%. Further, the invention is not limited by the precise manner in which alternate word candidates and probabilities can be stored, organized, or represented. For example, the word candidates can be listed for each recognition result in addition to a conditional probability for each of the word candidates.

As shown in FIG. 4, each recognition result need not correspond to alternate word candidates. For example, in FIGS. 3A and 3B, the letters H, I, U, W, X, and Y were not identified as being incorrect recognition results for a received user spoken utterance during the empirical analysis. Thus, in FIG. 4, the letters H, I, U, W, X, and Y do not have corresponding alternate word candidates. Those skilled in the art will recognize that the range of alternate word candidates for a given recognition result can range from 0 to n−1 where n is the number of words the speech recognition system is capable of recognizing.

The method of the invention disclosed herein can be implemented in a semi-automated manner within a speech recognition system. For example, during operation, the speech recognition system can store user corrections of incorrectly recognized text. The stored corrections can be interpreted as the actual received spoken word for purposes of comparison against the incorrectly recognized text. In this manner, the speech recognition system can develop alternate word candidates over time during the course of normal operation.

The present invention can be realized in hardware, software, or a combination of hardware and software. In accordance with the inventive arrangements, the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The system disclosed herein can be implemented by a programmer, using commercially available development tools for the particular operating system used. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other specific forms without departing from the spirit or essential attributes thereof, and accordingly reference should be made to the following claims, rather than to the foregoing specification, as indicating the scope of the invention.

What is claimed is:

1. A method of speech recognition comprising:
receiving at least one spoken word and performing speech recognition to determine a recognition result;
comparing said spoken word to said recognition result to determine if said recognition result is an incorrectly recognized word; and
identifying said spoken word as an alternate word candidate for said incorrectly recognized word.

2. The method of claim 1, further comprising:
presenting said alternate word candidate as a replacement for a subsequent recognition result.

3. The method of claim 1, further comprising:
calculating a conditional probability for said alternate word candidate.

4. The method of claim 3, wherein said alternate word candidate has a conditional probability greater than a predetermined minimum threshold.

5. The method of claim 1, further comprising:
storing and associating said incorrectly recognized word and said alternate word candidate in a data store.

6. The method of claim 3, further comprising:
storing and associating said incorrectly recognized word and said alternate word candidate in a data store wherein said data store includes an indication of said conditional probability corresponding to said alternate word candidate.

7. The method of claim 3, further comprising:
storing and associating said incorrectly recognized word, said alternate word candidate, and said conditional probability corresponding to said alternate word candidate in a data store.

8. The method of claim 1, wherein said spoken word is received directly from said
at least one speaker.

9. The method of claim 1, wherein said spoken word is recorded and provided to
the speech recognition system.

10. The method of claim 1, wherein said spoken word is a character.

11. The method of claim 1, wherein said spoken word is a letter.

12. A method of speech recognition comprising:
receiving at least one spoken word and performing speech recognition to determine a recognition result;
comparing said spoken word to said recognition result to determine if said recognition result is an incorrectly recognized word;
identifying said spoken word as an alternate word candidate for said incorrectly recognized word;
calculating a conditional probability for said alternate word candidate; and
storing and associating said incorrectly recognized word and said alternate word candidate in a data store wherein said data store includes an indication of said conditional probability corresponding to said alternate word candidate.

13. A method of speech recognition comprising:
receiving at least one spoken letter and performing speech recognition to determine a recognition result;
comparing said spoken letter to said recognition result to determine if said recognition result is an incorrectly recognized letter;
identifying said spoken letter as an alternate letter candidate for said incorrectly recognized letter;
calculating a conditional probability for said alternate letter candidate; and
storing and associating said incorrectly recognized letter and said alternate letter candidate in a data store wherein said data store includes an indication of said conditional probability corresponding to said alternate letter candidate.

14. A machine readable storage, having stored thereon a computer program having a plurality of code sections executable by a machine for causing the machine to perform the steps of:
receiving at least one spoken word and performing speech recognition to determine a recognition result;
comparing said spoken word to said recognition result to determine if said recognition result is an incorrectly recognized word; and
identifying said spoken word as an alternate word candidate for said incorrectly recognized word.

15. The machine readable storage of claim 14, further comprising:
presenting said alternate word candidate as a replacement for a subsequent recognition result.

16. The machine readable storage of claim 14, further comprising:
calculating a conditional probability for said alternate word candidate.

17. The machine readable storage of claim 16, wherein said alternate word candidate has a conditional probability greater than a predetermined minimum threshold.

18. The machine readable storage of claim 14, further comprising:
storing and associating said incorrectly recognized word and said alternate word candidate in a data store.

19. The machine readable storage of claim 16, further comprising:
storing and associating said incorrectly recognized word and said alternate word candidate in a data store wherein said data store includes an indication of said conditional probability corresponding to said alternate word candidate.

20. The machine readable storage of claim 16, further comprising:
storing and associating said incorrectly recognized word, said alternate word candidate, and said conditional probability corresponding to said alternate word candidate in a data store.

21. The machine readable storage of claim 14, wherein said spoken word is received directly from said at least one speaker.

22. The machine readable storage of claim 14, wherein said spoken word is recorded and provided to the speech recognition system.

23. The machine readable storage of claim 14, wherein said spoken word is a character.

24. The machine readable storage of claim 14, wherein said spoken word is a letter.

25. A machine readable storage, having stored thereon a computer program having a plurality of code sections executable by a machine for causing the machine to perform the steps of:
receiving at least one spoken word and performing speech recognition to determine a recognition result;
comparing said spoken word to said recognition result to determine if said recognition result is an incorrectly recognized word;
identifying said spoken word as an alternate word candidate for said incorrectly recognized word;
calculating a conditional probability for said alternate word candidate; and
storing and associating said incorrectly recognized word and said alternate word candidate in a data store wherein said data store includes an indication of said conditional probability corresponding to said alternate word candidate.

26. A machine readable storage, having stored thereon a computer program having a plurality of code sections executable by a machine for causing the machine to perform the steps of:
receiving at least one spoken letter and performing speech recognition to determine a recognition result;
comparing said spoken letter to said recognition result to determine if said recognition result is an incorrectly recognized letter;
identifying said spoken word as an alternate word candidate for said incorrectly recognized letter;
calculating a conditional probability for said alternate letter candidate; and
storing and associating said incorrectly recognized letter and said alternate letter candidate in a data store wherein said data store includes an indication of said conditional probability corresponding to said alternate letter candidate.
